(19) United States
(12) Patent Application Publication
(10) Pub. No.: US 2023/0183132 A1
(43) Pub. Date: Jun. 15, 2023

(54) COLOR CONTROL AND HEAT RECUPERATION WHEN PRODUCING ACTIVATED CLAY

(71) Applicant: FLSmidth A/S, Valby (DK)

(72) Inventors: Rasmus Franklin Momme, Vanlose (DK); Klaus Christian Thorslund, Hillerød (DK)

(21) Appl. No.: 17/923,579

(22) PCT Filed: Apr. 27, 2021
(86) PCT No.: PCT/EP2021/060906

§ 371 Date: Nov. 5, 2022

(30) Foreign Application Priority Data
May 5, 2020 (DK) PA 2020 00536

(51) Int. Cl. C04B 14/12; C04B 14/10; C04B 20/06; C04B 28/02

(52) U.S. Cl. CPC C04B 14/12; C04B 14/108; C04B 20/068; C04B 28/02; C04B 2103/0088

(57) ABSTRACT

The invention relates to a method for producing a supplementary cementitious material for use in a cement product or concrete, the method comprising the steps of activating clay to the supplementary cementitious material at between 600 to 1000 degree Celsius; treating the activated supplementary cementitious material under reduced conditions to form a reduced product and cooling the reduced product to 300-400 degrees Celsius by a quenching process under oxidizing conditions.

### FIELD OF THE INVENTION

This invention relates to an apparatus and method for color control and heat recuperation when producing activated clay in cement plants.

### BACKGROUND OF THE INVENTION

In cement industries, there is a significant market interest to produce color controlled activated clay as a supplementary cementitious material to lower the clinker content in cement. State of the art technology does only have limited heat recuperation as the heated activated clay is cooled under oxygen deployed conditions such as water quenching hydro air fluid bed coolers, to prevent reduced activated clay originally containing Iron (III) species to revers back to Iron (III) species.

This is not limited to clay only but all raw materials or mixtures containing Iron (III) species or other minerals giving an off color if not reduced during or after heat treatment and which has the potential by heat treatment to activate it to become a better supplementary cementitious material.

It is desired to minimize energy consumption and reduce the carbon footprint and, from a commercial point of view, to reduce production costs (energy consumption) as much as possible. It would be advantageous to be able to develop a method to overcome one or more of the above-mentioned problems.

### OBJECT OF THE INVENTION

It is an object of the present invention to overcome or at least alleviate one or more of the above problems of the prior art and/or provide the consumer with a useful or commercial choice.

It is an object of the present invention to provide a method for producing a supplementary cementitious material for use in a cement product.

It is another object of the present invention to provide an apparatus for producing a supplementary cementitious material for use in a cement product.

It is a further object of the present invention to provide an alternative to the prior art.

### SUMMARY OF THE INVENTION

In a first aspect, the invention relates to a method for producing a supplementary cementitious material for use in a cement product or concrete, the method comprising the steps of
Activating a clay to a supplementary cementitious material at between 600 to 1000 degree Celsius;
treating the activated supplementary cementitious material under reduced conditions to form a reduced product and
cooling the reduced product to maximum 500 degrees Celsius, preferably maximum 300 degrees Celsius by a quenching process under oxidizing conditions.

The reduced product may be cooled to 300-400 degrees Celsius by a quenching process under oxidizing conditions.

The cooling is preferably performed with a single and/or multi step quench cooling rate with an average temperature change of minimum 10 degrees Celsius/second and preferably average temperature change of minimum 100 degrees Celsius/second.

The quenching process may be performed in oxidizing conditions using an oxygen source such as atmospheric air.

The advantage is that by using atmospheric air, the air can be preheated, and then used as combustion air in the thermal treatment of activating the clay. By preheating the combustion air, significantly lower fuel consumption is achieved. If quenching was performed with e.g. inert gas or water then the heat is lost and cannot be recovered for the combustion process.

The quenching process is preferably performed in oxidizing conditions optionally using ambient air.

In another embodiment of the present invention, the oxygen preferably has a concentration of more than 10 vol % oxygen. When applying oxygen rich gas containing>10 vol % oxygen on dry basis, ideally atmospheric air as cooling media in multiple stage cyclone coolers or fluid bed cooler subsequently after the thermal activation of clay at 600 to 1000 degrees Celsius. Instead of traditional oxygen deployed coolers this enables to recuperate the heat to the cooling media and reuse as preheated oxygen/combustion air for the clay heating process and lowering the energy consumption producing activated clay, while still ensuring the majority of iron is not reversed back to red Iron (III) species (Fe2O3). This ensure to have a blended cement product consisting of 5 to 90% activated clay on dry weight basis visually perceived as a grey product color or a concrete consisting of 0.5 to 30% activated clay on dry weight visually perceived as a grey concrete.

The oxygen is preferably preheated in a single or multiple stage cyclone cooler, fluid bed cooler or a combination hereof.

In a preferred embodiment of the present invention the quenching process is performed with an air ratio of 0.01 to 20, such as 0.1 to 10, preferably 0.25 to 4.0 kg air/kg supplementary cementitious material to below 400 degrees Celsius and preferably 300 degrees Celsius. This ensures a rapid temperature reduction of the reduced activated clay thereby significantly slowing to preventing the reaction kinetic of reduced iron compounds to re-oxidize to Iron (III) species.

The quenching process may be performed with an air ratio of 0.01 to 20, such as 0.1 to 10, preferably 0.25 to 4.0 kg air/kg supplementary cementitious material to below 500 degrees Celsius and preferably 300 degrees Celsius so as to rapidly slow and stop reaction kinetics of iron compounds that else can re-oxidize to Iron (III) species.

The heated oxygen rich quenching air may be recuperated as combustion air in a pyro-process to lower a specific fuel consumption and CO2 emission of the activated supplementary cementitious material, and/or recuperated as drying air for raw material drying.

A color of a blended cement composition may be perceived grey when 5 to 90% by weight of said cement composition is consisting of said reduced product.

A color of a concrete may be perceived grey when 0.5 to 30% by dry weight of said concrete composition is consisting of said reduced product.

In another embodiment of the present invention, a color of a blended cement composition is perceived grey when 5 to 90% by weight of said cement composition is consisting of said reduced product and may further comprise an addition of dark color giving material, such as magnetite.

In yet another embodiment of the present invention, a color of a concrete may be perceived grey when 0.5 to 30% by weight of said concrete composition is consisting of said reduced product.

A color of a concrete composition may be perceived grey when 0.5 to 30% by weight of said concrete composition is consisting of said reduced product and may further comprise an addition of dark color giving material, such as magnetite.

In a preferred embodiment of the present invention the supplementary cementitious material may be activated clay.

In another embodiment of the present invention the supplementary cementitious material may be activated mixed clays or mixture of active clays.

The supplementary cementitious material may be in the form of activated shale or mixtures of activated shales

The supplementary cementitious material may be mixed activated shales.

The supplementary cementitious material may be a mixture of activated clay and activated shale or mixtures thereof.

The supplementary cementitious material is preferably used as cement substitute or a clinker substitute.

In a second aspect, the invention relates to an apparatus for producing a supplementary cementitious material for use in a cement product, the apparatus may utilize any of the methods mentioned above.

The apparatus preferably comprises a fan configured for creating a draft through a preheater, a filter for collecting product dried clay, a feed bin for the dried clay, a crusher/dryer for clay, one or more cyclone for preheating of the clay, a calciner/combustion vessel, a reduction vessel for color control, one or more quenching and cooling cyclones, a fan supplying oxygen rich air and the option of additional color control of the activated product by adding a dark colored product such as magnetite to hide any off color product impurities such as red in a blended cement of concrete.

The apparatus is preferably used to activate clay to a supplementary cementitious material of grey colour.

In a third aspect, the invention relates to a blended cement composition comprising 5 to 90% by weight of a calcined supplementary cementitious material manufactured according to any of the methods mentioned above.

The first, second and third aspects of the present invention may be combined.

In the present context a number of terms are used in a manner being ordinary to the skilled person. Some of these terms are detailed below:

Supplementary cementitious material is preferably used to mean/denote a material which contribute to the properties of hardened concrete through hydraulic or pozzolanic activity when used in concrete either in blended cement or added separately to the concrete.

### BRIEF DESCRIPTION OF THE FIGURES

The figures show one way of implementing the present invention and is not to be construed as being limiting to other possible embodiments falling within the scope of the attached claim set.

Embodiments of the invention, by way of example only, will be described with reference to the accompanying figures in which:

FIG. 1 schematically illustrates an apparatus according to the present invention, from a side view.

FIG. 2 schematically illustrates the steps of the method according to the present invention.

### DETAILED DESCRIPTION OF THE INVENTION

In a first aspect the invention relates to a method for producing a supplementary cementitious material for use in a cement product. The method comprises the steps of
Activating clay to a supplementary cementitious material at between 600 to 1000 degree Celsius;
treating the activated supplementary cementitious material under reduced conditions to form a reduced product and
cooling the reduced product to maximum 500 degrees Celsius, preferably maximum 300 degrees Celsius by a quenching process under oxidizing conditions.

The reduced product may be cooled to 300-400 degrees Celsius by a quenching process under oxidizing conditions.

In another preferred embodiment, the cooling may further be performed with a single and/or multi step quench cooling rate with an average temperature change of minimum 10 degrees Celsius/second and preferably average temperature change of minimum 100 degrees Celsius/second.

In another embodiment of the present invention, the calcining and treatment of the supplementary cementitious material may be performed simultaneously.

The quenching process is performed in oxidizing conditions using an oxygen source. Ambient air may alternatively be used in the oxidizing conditions optionally.

The activation of the clay is done by heat treatment, in the range of 600-1000 degrees Celsius, depending on the clay minerals, in a calciner, fluid bed or rotary kiln and will during this activation process or after the activation process be processed at the same temperature range but in a reducing environment to reduce Iron (III) species (Fe2O3) in the clay to an iron oxidation stage that is not red as Iron (III) species. The product subsequently is being cooled below 300-400 degrees Celsius to prevent the oxidation back to Iron (III) species to preserve the overall grayish color of the activated clay. The cooling media is a non-inert gas which is recuperated as preheated oxygen source for combustion of fuel during thermal heat treatment to activate the clay.

The oxygen added under the cooling sequence has a concentration of more than 10 vol % oxygen; with oxygen is meant O₂.

After the thermal activation and reduction of clay at 600 to 1000 degrees Celsius. Ideally ambient atmospheric air is used as quenching cooling media in multiple stage cyclone coolers or fluid bed cooler. Instead of traditional cooling under reducing conditions or water quenching coolers this enables to recuperate the heat to the cooling media and reuse as preheated oxygen/combustion air for the clay heating process and lowering the energy consumption producing activated clay, while still ensuring the majority of iron is not reversed back to red Iron (III) species (Fe2O3). In this way it is ensured to have a blended cement product consisting of 5 to 90% activated clay on dry weight basis visually perceived as a grey color blended cement or concrete consisting of 0.5 to 30% activated clay on dry weight basis visually perceived as grey color concrete.

The oxygen is preheated in a single or multiple stage cyclone cooler, fluid bed cooler or a combination hereof. The quenching process is performed with an air ratio of 0.01 to 20, such as 0.1 to 10, preferably 0.25 to 4.0 kg air/kg supplementary cementitious material to below 400 degrees Celsius and preferably 300 degrees Celsius to slow and stop the reverse reaction kinetic of iron compounds that else can re-oxidize to Iron (III) species.

In another embodiment of the present invention, the quenching process is performed with an air ratio of 0.01 to 20, such as 0.1 to 10, preferably 0.25 to 4.0 kg air/kg supplementary cementitious material to below 500 degrees Celsius and preferably 300 degrees Celsius so as to rapidly slow and stop reaction kinetics of iron compounds that else can re-oxidize to Iron (III) species.

The heat recuperated in the cooling media and used as combustion air in a pyroprocess lowers the specific fuel consumption of the activated supplementary cementitious material. A color of a blended cement composition or concrete is perceived grey when 5 to 90% by weight in the blended cement composition is consisting of the reduced product or 0.5 to 30% by dry weight in the concrete composition is consisting of the reduced product.

In another embodiment, the color of a blended cement composition is perceived grey when 5 to 90% by dry weight of said blended cement composition is consisting of said reduced product and further comprising an addition of dark color giving material, such as magnetite.

In another embodiment, the color of a concrete composition is perceived grey when 0.5 to 30% by dry weight of said concrete composition is consisting of said reduced product and further comprising an addition of dark color giving material, such as magnetite.

A color of a concrete composition is perceived grey when 0.5 to 30% by weight of the concrete composition is consisting of the reduced product.

A color of a concrete composition is perceived grey when 0.5 to 30% by weight of the concrete composition is consisting of the reduced product and further comprising an addition of dark color giving material, such as magnetite.

The supplementary cementitious material is preferably activated shale or mixture of activated shales.

In another embodiment the supplementary cementitious material is mixtures of activated clay and activated shale or mixtures thereof.

In yet another embodiment, the supplementary cementitious material is used as a cement substitute or clinker substitute in concrete, more specifically in the curing process.

The supplementary cementitious material used is preferably activated clay, but may be in the form of activated mixed clay or activated shale, or a combination thereof.

In a preferred embodiment the supplementary cementitious material is clay, such as mixed clays. Calcining a mixed clay or similar potential supplementary cementitious material or mix of materials that are activated by heating of the raw meal in a calciner, kiln or fluid bed between 600 and 1000 degrees Celsius to improve the reactivity of the particular material to become a better supplementary cementitious material when replacing clinker in a cement or used directly in concrete composition. The activated clay (or similar) is treated in the pyro process or after the pyro process at 600 to 1000 degrees Celsius in reducing atmosphere to form a reduced product where converting the product color reddish color to grey color. This is in particularly important and dominating for raw material containing Iron (III) species (Fe2O3) in iron oxidation stage 3 that is reduced to a lower oxidation stage. The reduced product at 600 to 1000 degrees Celsius is then quenched in oxidizing conditions using fresh air or other oxygen source with more than 10 vol % oxygen, dry in a single or multiple stage cyclone cooler, fluid bed cooler or combination hereof with an air ratio of 0.25 to 4.0 kg air/kg product to below 400 degrees Celsius and preferably 300 degrees Celsius to rapidly slow and stop the reaction kinetic of the iron compounds that else can re-oxidize back to Iron (III) species. The heated oxygen rich quenching air is recuperated as combustion air in the pyroprocess to lower the specific fuel consumption of the activated clay and/or recuperated as drying air for raw material drying. The color of the blended cement is perceived grey when 5 to 90% by dry weight of the blended cement is consisting of the activated clay (or similar heat-treated supplementations material).

Or the color of the concrete is perceived grey when 0.5 to 30% by dry weight of the concrete is consisting of the activated clay (or similar heat-treated supplementations material).

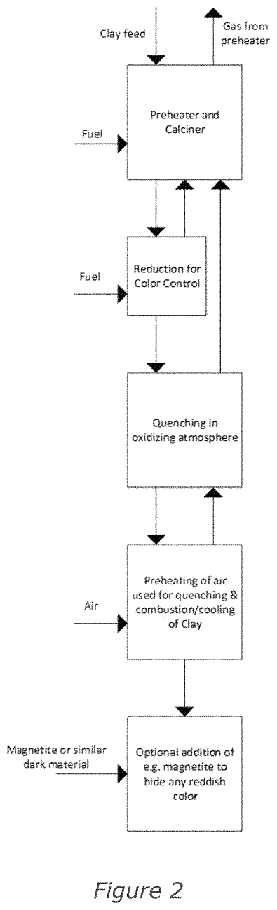

FIG. 2 schematically illustrates the steps of the method according to the present invention.

Starting from the upper most box (preheater and Calciner) and going downwards, the steps of the method according to the present inventions are:

Preheater and calciner: Clay is fed to the system and the material is preheated in a number of cyclones stages before it enters the calciner (combustion vessel). Hot combustion air is draft from the reduction vessel and the quencher. Fuel is supplied for the combustion in a controlled way to the combustion vessel. The heat-treated and activated clay is collected in a cyclone and sent to the reduction vessel.

Reduction for color control: A color control is taking place under reduction reducing conditions in the vessel for color control. The reducing atmosphere is created by sub-stoichiometric combustion of the fuel. The material is then sent to the quenching.

Quenching in oxidizing atmosphere: A very fast quenching is performed in an oxidizing atmosphere in order to maintain the greyish color obtain in. The quenching can e.g. be done in a cyclone. The material collected in the cyclone is sent to further cooling.

Preheating of air used for quenching & combustion/cooling of Clay: The Clay is further cooled in one or several steps e.g. by using ambient air. The preheater ambient air is used for the quenching in and further in for the fuel combustion in.

Optional addition of e.g. magnetite to hide any reddish color: Optional addition of dark additive to hide any reddish color. This step is not necessarily an integrated part of the above process but can also be done later in the process e.g. in the finish grinding of the cement.

In a second aspect the invention relates to an apparatus for producing a supplementary cementitious material for use in a blended cement product or concrete.

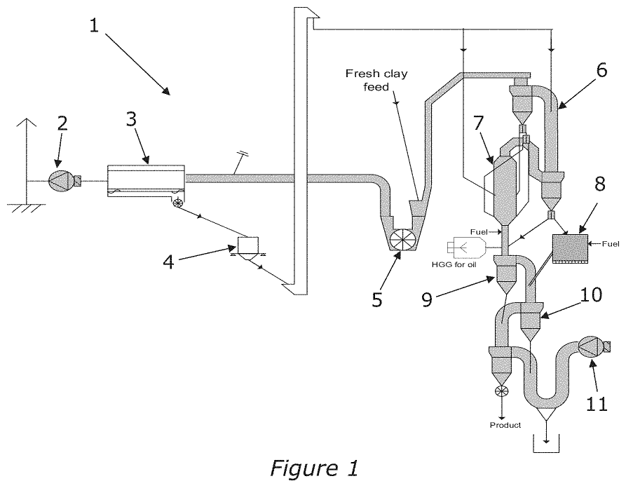

FIG. 1 schematically illustrates an apparatus for producing a supplementary cementitious material for use in a blended cement product or concrete.

The apparatus 1 comprises a fan 2 configured for creating a draft through a preheater, a filter 3 for collecting product dried clay, a feed bin 4 for the dried clay, a crusher/dryer 5 for clay, one or more cyclone 6 for preheating of the clay, a calciner/combustion vessel 7, a reduction vessel 8 for color control, a quenching cyclone 9, a cooling cyclone 10 and a fan for cooling 11.

The apparatus is used to activate clay to a supplementary cementitious material of grey color.

In a third aspect, the invention relates to a cement composition comprising 5 to 90% by weight of a calcined SCM manufactured by utilizing any of the above mention methods

The invention relates to a concrete composition comprising 0.5 to 30% by dry weight of a calcined SCM manufactured by utilizing any of the above mention methods.

Although the present invention has been described in connection with the specified embodiments, it should not be construed as being in any way limited to the presented examples. It should also be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

List of references:
1: Apparatus for producing a supplementary cementitious material
2: Fan to create the draft through the preheater
3: Filter for collecting the product dried clay
4: Feed bin for dried clay
5: Crusher/dryer for clay
6: Cyclone(s) for preheating of the clay
7: Calciner/combustion vessel
8: Reduction vessel for color control
9: Quenching cyclone
10: Cooling cyclone(s)
11: Fan for cooling CLAIMS

1. A method for producing a supplementary cementitious material for use in a cement product or concrete, the method comprising the steps of
activating clay to the supplementary cementitious material at between 600 to 1000 degree Celsius;
treating the activated supplementary cementitious material, after the activation of clay at a temperature between 600 to 1000 degrees Celsius, under reducing conditions to form a reduced product; and
cooling the reduced product to a temperature in a range of 300 to 500 degrees Celsius, at a cooling rate with an average temperature change in the range of 10 to 100 degrees Celsius/second, by a quenching process under oxidizing conditions to rapidly slow and stop reaction kinetics of iron compounds that else can re-oxidize to Iron (III) species.

2. The method for producing a supplementary cementitious material according to claim 1, wherein the reduced product is cooled to 300-400 degrees Celsius by a quenching process under oxidizing conditions.

3. The method for producing a supplementary cementitious material according to claim 1, wherein the cooling is performed with a single and/or multi step quench cooling.

4. The method for producing a supplementary cementitious material according to claim 1, wherein the quenching process is performed in oxidizing conditions using an oxygen source.

5. The method for producing a supplementary cementitious material according to claim 1, wherein then quenching process is performed in oxidizing conditions using ambient atmospheric air.

6. The method for producing a supplementary cementitious material according to claim 1, wherein said oxygen has a concentration of more than 10 vol % oxygen.

7. The method for producing a supplementary cementitious material according to claim 6, wherein said oxygen is preheated in a single or multiple stage cyclone cooler, fluid bed cooler or a combination hereof.

8. The method for producing a supplementary cementitious material according to claim 1, wherein said quenching process is performed with an air ratio of 0.01 to 20, such as 0.1 to 10, preferably 0.25 to 4.0 kg air/kg supplementary cementitious material to below 400 degrees Celsius and preferably 300 degrees Celsius.

9. The method for producing a supplementary cementitious material according to claim-8, wherein said quenching process is performed with an air ratio of 0.01 to 20, such as 0.1 to 10, preferably 0.25 to 4.0 kg air/kg supplementary cementitious material to below 500 degrees Celsius and preferably 300 degrees Celsius.

10. The method for producing a supplementary cementitious material according to claim 1, wherein heated quenching air containing oxygen, wherein the oxygen concentration in the quenching air is more than 10 vol % oxygen, is recuperated as combustion air in a pyroprocess to lower a specific fuel consumption of the activated supplementary cementitious material, and/or recuperated as drying air for raw material drying.

11. The method for producing a supplementary cementitious material according to claim 1, wherein the supplementary cementitious material is blended with a cement product, wherein a color of the blended cement composition is perceived grey when 5 to 90% by weight of said cement composition is consisting of said reduced product.

12. The method for producing a supplementary cementitious material according to claim 1, wherein the supplementary cementitious material is blended with a cement product, wherein a color of the blended cement composition is perceived grey when 5 to 90% by weight of said cement composition is consisting of said reduced product and further comprising an addition of dark color giving material, such as magnetite.

13. The method for producing a supplementary cementitious material according to claim 1, wherein the supplementary cementitious material is blended with concrete, wherein a color of a concrete composition is perceived grey when 0.5 to 30% by weight of said concrete composition is consisting of said reduced product.

14. The method for producing a supplementary cementitious material according to claim 1, wherein the supplementary cementitious material is blended with concrete, wherein a color of a concrete composition is perceived grey when 0.5 to 30% by weight of said concrete composition is consisting of said reduced product and further comprising an addition of dark color giving material, such as magnetite.

15. The method for producing a supplementary cementitious material according to claim 1, wherein the supplementary cementitious material is activated clay.

16. The method for producing a supplementary cementitious material according to claim 1, wherein the supplementary cementitious material is activated mixed clays or mixture of active clays.

17. The method for producing a supplementary cementitious material according to claim 1, wherein the supplementary cementitious material is activated shale.

18. The method for producing a supplementary cementitious material according to claim 1, wherein the supplementary cementitious material is activated mixed shales or mixtures of activated shales.

19. The method for producing a supplementary cementitious material according to claim 1, wherein the supplementary cementitious material is mixtures of activated clay and activated shale or mixtures thereof.

20. The method for producing a supplementary cementitious material according to claim 1, wherein the supplementary cementitious material is blended with concrete as a cement substitute or a clinker substitute.

21. An apparatus (1) utilizing the method according to claim 1, said apparatus comprising:
a fan (2) configured for creating a draft through a preheater;
a filter (3) for collecting product dried clay;
a feed bin (4) for receiving the dried clay;
a crusher/dryer (5) for clay;
one or more cyclone (6) for preheating of the clay;
a calciner/combustion vessel (7) for activating clay to the supplementary cementitious material at a temperature between 600 to 1000 degree Celsius;
a reduction vessel (8) configured to receive the activated clay for color control;
a quenching cyclone (9) and a cooling cyclone (10) configured for cooling the reduced product to a temperature in a range of 300 to 500 degrees Celsius, at a cooling rate with an average temperature change in the range of 10 to 100 degrees Celsius/second, by a quenching process under oxidizing conditions to rapidly slow and stop reaction kinetics of iron compounds that else can re-oxidize to Iron (III) species; and
a fan for cooling (11).

22. The apparatus according to claim 21, for use to activate clay to a supplementary cementitious material of grey color.

23. The method for producing a supplementary cementitious material according to claim 1, wherein the supplementary cementitious material is blended with a cement product to obtain a blended cement composition, wherein the blended cement composition comprises 5 to 90% by weight of a calcined supplementary cementitious material.
